(19) United States
(12) Patent Application Publication
(10) Pub. No.: US 2008/0138790 A1
(43) Pub. Date: Jun. 12, 2008

(54) Methods and Compositions for Simultaneously Isolating Hemoglobin from Red Blood Cells and Inactivating Viruses

(76) Inventors: Robert M. Winslow, La Jolla, CA (US); Kim D. Vandegriff, San Diego, CA (US); Ashok Malavalli, San Diego, CA (US)

Correspondence Address: GORDON & REES LLP, 101 WEST BROADWAY, SUITE 1600, SAN DIEGO, CA, 92101, US

(21) Appl. No.: 11/578,441

(22) PCT Filed: Apr. 12, 2005
(86) PCT No.: PCT/US05/12484

§ 371 Date: Aug. 6, 2007

Related U.S. Application Data
(60) Provisional application No. 60/561,643, filed on Apr. 13, 2004.

(51) Int. Cl. A01N 1/02

(52) U.S. Cl. 435/2

(57) ABSTRACT

The present invention relates to methods arid compositions for isolating hemoglobin from red blood cells. Such methods and compositions also facilitate viral inactivation in a manner that allows recovery of biologically active hemoglobin. More particularly, this method relates to the use of solvents and detergents that are capable of facilitating red blood cell lysis to release hemoglobin (and solubilizing red blood cell membranes), while simultaneously inactivating viruses.

### TECHNICAL FIELD

The present invention relates to methods and compositions for isolating hemoglobin from red blood cells. Such methods and compositions also facilitate viral inactivation in a manner that allows recovery of biologically active hemoglobin. More particularly, this method relates to the use of solvents and detergents that are capable of facilitating red blood cell lysis to release hemoglobin (and of solubilizing red blood cell membranes to facilitate hemoglobin isolation) while simultaneously inactivating viruses.

### BACKGROUND OF THE INVENTION

Hemoglobin is an ingredient in many different pharmaceutical preparations. Most notably, hemoglobin is the starting material for the production of blood substitute products, such as Hemospan™ (Sangart, Inc., San Diego, Calif.). As such, hemoglobin must be readily available in production-sized quantities to use in the development and eventual commercialization of hemoglobin based blood substitutes, which are also referred to as hemoglobin based oxygen carriers (HBOC).

Any pharmaceutical product, including hemoglobin, must be free of viruses before it is suitable for administration. In particular, pharmaceutical products that are designed for intravenous injection into humans, and especially products derived from blood, must be free of highly contagious viruses, such as hepatitis B virus (HBV), hepatitis C virus (HCV) and human immunodeficiency virus (HIV). Many such products are human blood-based, which heightens the risk of human virus contamination in the product. Accordingly, advancements in the field of “blood product viral inactivation” are important to ensure that pharmaceutical products are safe for administration.

One of the many problems associated with viral inactivation is that many viruses are encapsulated by lipids, which necessitates a harsher treatment to make sure that they are completely inactivated. Such treatments, while effective at inactivating viruses, may diminish or even destroy the biological activity of the blood product from which virus are being inactivated. Therefore, the number of available procedures is somewhat limited, and often times two or more individual procedures must be combined to achieve viral inactivation without destroying biological activity.

There are currently many different methods for inactivating viruses, such as heat-inactivation, solvent/detergent inactivation, alkalizing agents, and ultraviolet irradiation. Of these, solvent/detergent inactivation is perhaps the most widely accepted method of inactivating viruses in blood products. This is because nearly all of the significant transfusion-transmissible pathogens, such as HCV and HIV, are lipid-enveloped viruses which are susceptible to membrane disruption by solvents and detergents.

Inactivation of viruses in hemoglobin-containing preparations is particularly complicated, in part because hemoglobin is a very complex protein. It has a molecular weight of approximately 64,000 Daltons and is composed of about 6% heme and 94% globin. In its native form, it contains two pairs of subunits (i.e., it is a tetramer), each containing a heme group and a globin polypeptide chain. In aqueous solution, hemoglobin is present in equilibrium between the tetrameric (MW 64,000) and dimeric forms (MW 32,000); outside of the RBC, the dimers are prematurely excreted by the kidney (plasma half-life of approximately 2-4 hours).

Hemoglobin's biological activity is directly related to its oxygen carrying capacity and characteristics. Because of its complexity, it is rather sensitive to many environmental conditions, some of which maybe detrimental to its ability to carry oxygen. Thus, any method for viral inactivation of hemoglobin must be carefully tailored to ensure that the end product maintains a suitable amount of biological activity.

Accordingly, there is a need for methods and compositions that are capable of inactivating viral contaminants of hemoglobin preparations without destroying the crucial biological activity of hemoglobin.

### SUMMARY OF THE INVENTION

The present invention relates to methods and compositions for isolating hemoglobin from red blood cells. Such methods and compositions also facilitate viral inactivation in a manner that allows recovery of biologically active hemoglobin. More particularly, this method relates to the use of solvents and detergents that are capable of facilitating red blood cell lysis to release hemoglobin (and of solubilizing red blood cell membranes to facilitate hemoglobin isolation), while simultaneously inactivating viruses.

In one embodiment, the method of isolating virus free hemoglobin from red blood cells includes the steps of contacting a suspension of intact or lysed red blood cells with a detergent and an organic solvent to produce free hemoglobin and stroma, and isolating the free hemoglobin from the stroma.

When the method of isolating virus free hemoglobin is performed with intact red blood cells, the method is accomplished by lysing the red blood cells by exposing the red blood cells, e.g., to a hypotonic solution. Examples of such solutions include water, buffer, or salt. Other methods for lysing red blood cells include, for example, exposing them to physical conditions, such as sonication, agitation or shear forces.

Once the intact or lysed red blood cells have been treated with solvent and detergent, the step of isolating the free hemoglobin from the stroma is accomplished. This method is performed, for example, by centrifugation, filtration, dialysis, or chromatography. The chromatography is preferably ion exchange chromatography.

The detergent used in the practice of this invention in producing free hemoglobin and stroma may be anionic, cationic, amphoteric, or nonionic. Preferably, the detergent is a nonionic detergent, because nonionic detergents tend to be less denaturing for proteins than ionic detergents. Polyoxyethylene derivatives of fatty acids are particularly contemplated for use in the present invention method, preferably polyoxyethylenesorbitan monooleate (Tween 80) or polyoxyethylated alkylphenol (Triton X-100).

The organic solvent contemplated in this invention in producing free hemoglobin and stroma may be in the class of ethers, alcohols or trialkyl phosphates, such as tri (n-butyl) phosphate (TNBP). In one embodiment, ether is used for viral inactivation in accordance with the invention, having the formula

R¹-O-R²

wherein, R¹ and R² are independently C₁ to C₁₈ unsubstituted or substituted alkyl or alkenyl groups, with the substitution being, for example, oxygen or sulfur atoms.

In another embodiment, the organic solvent is alcohol, preferably with 1-8 carbon atoms, for example, methanol, ethanol, propanol, isopropanol, n-butanol, isobutanol, n-pentanol or isopentanol.

The conditions used to isolate hemoglobin from red blood cells and facilitate viral inactivation, may be performed with the organic solvent having a concentration of about 0.01% to about 1.0% (v/v). The preferred concentration is at about 0.1% to about 0.5% (v/v). Typical results are achieved at 24° C. for a minimum of 4 hours, when the detergent is polyoxyethylated alkylphenol (Triton X-100), and 24° C. for a minimum of 6 hours, when the detergent is polyoxyethylenesorbitan monooleate (Tween 80). Some preparations can be treated successfully at 4° C.

In yet another embodiment of the present invention, the method results in the production of modified hemoglobin. In this method, there is an added step of contacting the free hemoglobin with an activated polyalkylehe oxide (PAO), such as polyethylene glycol (PEG), which results in the production of a modified polyalkylene oxide hemoglobin conjugate, such as PEG-Hb conjugates. This step may be performed simultaneously with the solvent and detergent step (step a)), in which case the “free hemoglobin” isolated in step b) is in the form of a PAO-Hb conjugate. Alternatively, it may be performed after step a), but before step b). Yet another alternative method involves contacting the free hemoglobin in step b) with the activated PAO during the isolation procedure or thereafter. In any of the aforementioned methods, the end result is the production of a PAO-Hb conjugate.

In a preferred method according to the present invention, virus free hemoglobin is isolated by contacting intact red blood cells with polyoxyethylenesorbitan monooleate (Tween 80) or polyoxyethylated alkylpheno (Triton X-100), and tri (n-butyl) phosphate (TNBP), to produce free hemoglobin and stroma, followed by isolation of the free hemoglobin.

Other aspects of the present invention are described throughout the specification.

### DESCRIPTION OF THE INVENTION

The present invention relates to methods and compositions for isolating virus free hemoglobin from red blood cells. Preparing hemoglobin solution from blood cells using conventional methods usually involves the steps of washing red blood cells, lysis of the red blood cells to release hemoglobin (“free hemoglobin”), and isolation of the hemoglobin from other red blood cell components, which includes the red blood cell membranes, or “stroma”. However, such conventional methods do not always result in hemoglobin preparations that are free of viral contaminants.

Many different methods have been developed for isolating hemoglobin from red blood cells. See, e.g., PCT WO 00/12591, which describes a batch process for isolating hemoglobin from red blood cells. However, most methods that are currently used to isolate hemoglobin have limitations with respect to yield, since the hemoglobin may become inactivated during the isolation process.

In order to remove viruses from hemoglobin solutions prepared from red blood cells, it is not sufficient simply to wash the red blood cells beforehand, since virus particles may remain associated with the red blood cells after the washing step. Thus, the isolation of hemoglobin from red blood cells up to now has required an additional step of virus inactivation, which results in an additional source of hemoglobin inactivation and loss of viable product.

The present invention relates to the incorporation of a method for inactivating viruses into a hemoglobin isolation method. Such a dual-purpose method allows many unnecessary process steps to be eliminated, which enhances yield while maintaining an extremely high level of safety.

More particularly, the present invention relates to the use of solvents and detergents that are capable of lysing red blood cells (and solubilizing red blood cell membranes) to release hemoglobin while simultaneously inactivating viruses. The method can be performed in a single lysis and virus inactivation step (i.e., a “one step method”), or lysis and virus inactivation can take place in separate steps (i.e., a “two step method”). Thus, in one embodiment of the present invention the red blood sells are lysed beforehand to liberate free hemoglobin, and thereafter exposed to solvent and detergent to solubilize the red blood cell membranes that remain after lysis and simultaneously inactivate contaminating viruses. In either method, viruses can be inactivated without first isolating hemoglobin from other red blood cell components, and the virus inactivation method has the added advantage that cellular debris is solubilized by the solvent and detergent making free hemoglobin easier to isolate.

### Definitions

To facilitate understanding of the invention set forth in the disclosure that follows, a number of terms are defined below.

The term “hemoglobin” refers generally to the protein contained within red blood cells that transports oxygen. Each molecule of hemoglobin has 4 subunits, 2 α chains and 2 β chains, which are arranged in a tetrameric structure. Each subunit also contains one heme group, which is the iron-containing center that binds oxygen. Thus, each hemoglobin molecule can bind 4 oxygen molecules.

The term “virus inactivation” refers to both “inactivation”, such that the virus can no longer infect cells and propagate, and virus removal per se. As such, the term “virus inactivation” refers generally to the process of making a substance completely free of infective viral contaminants.

The term “modified hemoglobin” includes, but is not limited to, hemoglobin altered by a chemical reaction such as intra- and inter-molecular cross-linking, genetic manipulation, polymerization, and/or conjugation to other chemical groups (e.g., polyalkylene oxides, for example polyethylene glycol, or other adducts such as proteins, peptides, carbohydrates, synthetic polymers and the like). In essence, hemoglobin is “modified” if any of its structural or functional properties have been altered from its native state. As used herein, the term “hemoglobin” by itself refers both to native, unmodified, hemoglobin, as well as modified hemoglobin.

The term “surface-modified hemoglobin” is used to refer to hemoglobin described above to which chemical groups such as dextran or polyalkylene oxide have been attached, most usually covalently. The term “surface modified oxygenated hemoglobin” refers to hemoglobin that is surface modified when it is in the oxygenated state.

The term “stroma-free hemoglobin” refers to hemoglobin from which all red blood cell membranes have been removed.

The term “MaIPEG-Hb” refers to hemoglobin to which malemidyl-activated PEG has been conjugated. Such MaIPEG may be further referred to by the following formula:

Hb-(S-Y-R-CH₂-CH₂-[O—CH₂-CH₂]ₙ—O—CH₃)ₘ Formula I

where Hb refers to tetrameric hemoglobin, S is a surface thiol group, Y is the succinimido covalent link between Hb and Mal-PEG, R is an alkyl, amide, carbamate or phenyl group (depending on the source of raw material and the method of chemical synthesis), [O—CH₂-CH₂]ₙ are the oxyethylene units making up the backbone of the PEG polymer, where n defines the length of the polymer (e.g., MW=5000), and O—CH₃ is the terminal methoxy group. PHP and POE are two different PEG-modified hemoglobin.

The term “plasma expander” refers to any solution that may be given to a subject to treat blood loss.

The term “oxygen carrying capacity,” or simply “oxygen capacity” refers to the capacity of a blood substitute to carry oxygen, but does not necessarily correlate with the efficiency in which it delivers oxygen. Oxygen carrying capacity is generally calculated from hemoglobin concentration, since it is known that each gram of hemoglobin binds 1.34 ml of oxygen. Thus, the hemoglobin concentration in g/dl multiplied by the factor 1.34 yields the oxygen capacity in ml/dl. Hemoglobin concentration can be measured by any known method, such as by using the β-Hemoglobin Photometer (HemoCue, Inc., Angelholn, Sweden). Similarly, oxygen capacity can be measured by the amount of oxygen released from a sample of hemoglobin or blood by using, for example, a fuel cell instrument (e.g., Lex-O₂-Con; Lexington Instruments).

The term “oxygen affinity” refers to the avidity with which an oxygen carrier such as hemoglobin binds molecular oxygen. This characteristic is defined by the oxygen equilibrium curve which relates the degree of saturation of hemoglobin molecules with oxygen (Y axis) with the partial pressure of oxygen (X axis). The position of this curve is denoted by the value, P50, the partial pressure of oxygen at which the oxygen carrier is half-saturated with oxygen, and is inversely related to oxygen affinity. Hence the lower the P50, the higher the oxygen affinity. The oxygen affinity of whole blood (and components of whole blood such as red blood cells and hemoglobin) can be measured by a variety of methods known in the art. (See, e.g., Winslow et al., J. Biol. Chem. 252(7):2331-37 (1977)). Oxygen affinity may also be determined using a commercially available HEMOX™ TM Analyzer (TCS Scientific Corporation, New Hope, Pa.). (See, e.g., Vandegriff and Shrager in “Methods in Enzymology” (Everse et al., eds.) 232:460 (1994)).

The term “oxygen-carrying component” refers broadly to a substance capable of carrying oxygen in the body's circulatory system and delivering at least a portion of that oxygen to the tissues. In preferred embodiments, the oxygen-carrying component is native or modified hemoglobin, and is also referred to herein as a “hemoglobin based oxygen carrier,” or “HBOC”.

The term “mixture” refers to a mingling together of two or more substances without the occurrence of a reaction by which they would lose their individual properties; the term “solution” refers to a liquid mixture; the term “aqueous solution” refers to a solution that contains some water and may also contain one or more other liquid substances with water to form a multi-component solution; the term “approximately” refers to the actual value being within a range, e.g. 10%, of the indicated value.

The term “polyethylene glycol” refers to liquid or solid polymers of the general chemical formula H(OCH₂CH₂)ₙOH, where n is greater than or equal to 4. Any PEG formulation, substituted or unsubstituted, can be used.

The meaning of other terminology used herein should be easily understood by someone of reasonable skill in the art.

Isolation of Hemoglobin from Red Blood Cells

The isolated hemoglobin prepared in accordance with the present invention may be either native (unmodified) hemoglobin, or it may be simultaneously or subsequently modified by a chemical reaction such as intra- or inter-molecular cross-linking, polymerization, or the addition of chemical groups (e.g., polyalkylene oxides, or other adducts).

The present invention is also not limited by the source of the hemoglobin. For example, the hemoglobin may be derived from any red blood cell-containing creature. Preferred sources of hemoglobin for certain applications are humans, cows, pigs and horses.

Hemoglobin is easily denatured under environmental stress, such as fluctuations in temperature or pH. It is also known to undergo oxidation. This can result in destabilization of the heme-globin complex and eventual denaturation of the globin chains. Both oxygen radical formation and protein denaturation are believed to play a role in in vivo toxicity of HBOCs (Vandegriff, K. D., Blood Substitutes, Physiological Basis of Efficacy, pages 105-130, Winslow et al., ed., Birkhauser, Boston, Mass. (1995)). Accordingly, methods for isolation of hemoglobin must be chosen to avoid the harmful effects of oxidation.

The individual steps involved in hemoglobin isolation from red blood cells are generally washing the cells, lysing the cells, and isolating the hemoglobin from other cellular components. The steps can be performed simultaneously or sequentially, in either a single batch process or a continual batch process in which all of the steps are being performed in a single reaction vessel as described in PCT WO 00/21591.

Each of these steps will be discussed individually below:

1. Washing the Cells

Generally, blood is collected from donors and pooled together in batch quantities. The extracellular components of blood, such as plasma proteins, are washed away by repeatedly diluting the cells in a wash solution, most usually normal saline, and discarding the diluent. The washing step is usually conducted under conditions which allow the cells to remain intact. Many such red blood cell washing methodologies are well known in the literature.

2. Lysing the Cells

Cells are lysed by exposing them to physical or chemical conditions that disrupt the cell membranes. For example, exposure to hypotonic solutions such as water or hypotonic buffer or salt solutions, results in cell lysis by inducing hypotonic shock. More importantly, in the practice of the present invention, cell lysis may be achieved at least in part by exposing the cells to a solvent-detergent combination, which disrupts the ionic interactions of cell membranes resulting in cell lysis, while simultaneously inactivating viral contaminants.

3. Isolating the Hemoglobin

Once the cells have been lysed, the hemoglobin is isolated from the cell membranes (i.e., “stroma”) using any physical or chemical means for separation, such as centrifugation, filtration, dialysis, chromatography, etc. Methods are well known in the art for isolating hemoglobin from lysed red blood cells. See, for example, Journal of Experimental Medicine, Vol. 126, pages 185 to 193, 1969; Annals of Surgery, Vol. 171, pages 615 to 622, 1970; Haematologia, Vol. 7, pages 339 to 346, 1973; and Surgery, Vol. 74, pages 198 to 203, 1973. A particularly useful method is ion exchange chromatography, such as DEAE (diethylaminoethyl) chromatography.

Various precipitation tests can be used to ascertain if the hemoglobin is stromal-free. Suitable tests are described in Hawk's Physiological Chemistry, pages 181 to 183, 1965, published by McGraw-Hill Company.

### Solvent-Detergent Treatment

The solvent-detergent (SD) viral inactivation technology has become the most widely used virucidal method for the treatment of plasma protein products around the world today. Studies show that various solvent-detergent formulations inactivate different viruses inoculated into plasma and plasma fractions, while preserving the content and biologic functions of selected plasma proteins.

The selection of solvent and detergent may be chosen using routine optimization. In general, a solvent/detergent combination should be chosen that is chemically compatible with the hemoglobin isolation methodology. Guidelines for solvent/detergent treatment are well known. For example, the World Health Organization (WHO) gives the following guidelines for solvent/detergent treatment:

Organic solvent/detergent mixtures disrupt the lipid membrane of enveloped viruses. Once disrupted, the virus no longer can bind to and infect cells. Non-enveloped viruses are not inactivated. Typical conditions which are used are 0.3% tri(n-butyl) phosphate (TNBP) and 1% nonionic detergent, either Tween 80 or Triton X-100, at 24° C. for a minimum of 4 hours with Triton X-100 or 6 hours with Tween 80. When using TNBP/Triton X-100, some preparations can be treated successfully at 4° C. Since high lipid content can adversely affect virus inactivation, the final selection of treatment conditions must be based on studies demonstrating virus inactivation, testing the worst case conditions; i.e., lowest permitted temperature and reagent concentration, highest permitted product concentration. Prior to treatment, solutions are filtered through a 1 micrometer filter to eliminate virus entrapped in particles. As an alternative, if filtration is performed after addition of the reagents, the filtration process should be demonstrated to not alter the levels of the added solvent and detergent. The solution is stirred gently throughout the incubation period. When implementing in a manufacturing environment, physical validation should confirm that mixing achieves a homogeneous solution and that the target temperature is maintained throughout the designated incubation period. Mixing homogeneity is best verified by measuring TNBP or detergent concentrations at different locations within the tank, although measuring dye distribution might be an acceptable substitute. To ensure that every droplet containing virus is contacted by the reagents, an initial incubation for 30-60 minutes is typically conducted in one tank after which the solution is transferred into a second tank where the remainder of the incubation is conducted. In this manner, any droplet on the lid or surface of the first tank which might not be contacted with the SD reagents is excluded. The use of a static mixer where reagents and plasma product are premixed prior to entrance into the tank is an acceptable alternate. The tank in which viral inactivation is completed is located in a separate room in order to limit the opportunity for post-treatment contamination. This room typically has its own dedicated equipment and may have its own air supply.

Accordingly, one exemplary method for solvent-detergent treatment that is used in conjunction with an ion exchange method for isolating hemoglobin combines the organic solvent tri (n-butyl) phosphate (TNBP) with the nonionic detergent, polyoxyethylated alkylphenol (Triton X-100), to achieve a high rate of virus kill with acceptable protein compatibility. Other similar combinations would be easily chosen by those of skill in the chemical arts.

The method of using solvent-detergent formulations as described herein is used not only for inactivation of viruses but also aids in the hemoglobin isolation process. By exposing either intact or lysed red blood cells to a combination of an organic solvent and a detergent, the red blood cell membranes and contaminating lipids can be solubilized thus making it easier to separate free hemoglobin from the other cellular constituents. In particular, lipid contaminants can be easily separated from free hemoglobin using the method of the present invention.

The solvent/detergent inactivation process with tri(n-butyl)phosphate (TNBP) with addition of detergents such as polyoxyethylenesorbitan monooleate (Tween 80), is very effective, and the preferred method in the inactivation of enveloped viruses and isolating virus free hemoglobin from red blood cells. Typical conditions which are used in accordance with the WHO guidelines are 0.3% TNBP and 1% non-ionic detergent, either Tween 80 or Triton X-100, at 24° C. for a minimum of 4 hours with Triton X-100 or 6 hours with Tween 80.

A. Organic Solvents

The organic solvent is preferably ether, alcohol or a trialkyl phosphate. Especially contemplated ethers include those having the formula

R¹-O-R²

wherein, R¹ and R² are independently C₁-C₁₈ alkyl or alkenyl which can contain an oxygen or sulfur atom, preferably C₁to C₁₈ alkyl or alkenyl. Preferred ethers include dimethyl ether, diethyl ether, ethyl propyl ether, methyl-butyl ether, methyl isopropyl ether and methyl isobutyl ether.

Preferred alcohols are those in which the-alkyl or alkenyl group is between 1 and 8 carbon atoms. Particularly contemplated alcohols include, for example, methanol, ethanol, propanol, isopropanol, n-butanol, isobutanol, n-pentanol and the isopentanols. The organic solvent is used at a concentration of about 0.01% to about 1.0% (v/v), preferably about 0.1% to about 0.5% (v/v).

The following table lists other exemplary organic solvents. (Please note that water and heavy water have been included for comparative purposes.)

TABLE 1
Organic Solvents

| | | Boiling | Melting | | Solubility | | LD₅₀ | Flash |
|---|---|---|---|---|---|---|---|---|
| | | Point | Point | Density | in H₂O | Relative | (oral-rat) | Point |
| Solvent | Formula | (° C.) | (° C.) | (g/mL) | (g/100 g) | polarity | (g/kg) | (° C.) |
| Acetic acid | C₂H₄O₂ | 118 | 16.6 | 1.049 | Miscible | 0.648 | 3.3 | 39 |
| Acetonitrile | C₂H₃N | 81.6 | −46 | 0.786 | Miscible | 0.460 | 3.8 | 6 |
| 1-Butanol | C₄H₁₀O | 117.6 | −89.5 | 0.81 | 7.7 | 0.602 | 0.79 | 35 |
| 2-Butanone | C₄H₈O | 79.6 | −86.3 | 0.805 | 25.6 | 0.327 | 2.7 | −7 |
| t-Butyl alcohol | C₄H₁₀O | 82.2 | 25.5 | 0.786 | Miscible | 0.389 | 3.5 | 11 |
| Diethylene glycol | C₄H₁₀O₃ | 245 | −10 | 1.118 | M | 0.713 | 13 | 143 |
| Diglyme | C₆H₁₄O₃ | 162 | −64 | 0.945 | M | 0.244 | | 57 |
| Dimethoxy- ethane (glyme) | C₄H₁₀O₂ | 85 | −58 | 0.868 | M | 0.231 | 10 | −6 |
| Dioxane | C₄H₈O₂ | 101.1 | 11.8 | 1.033 | M | 0.164 | 4.2 | 12 |
| Ethanol | C₂H₆O | 78.5 | −114.1 | 0.789 | M | 0.654 | 7.1 | 13 |
| Ether | C₄H₁₀O | 34.6 | −116.3 | 0.713 | 7.5 | 0.117 | 1.2 | −45 |
| Ethyl acetate | C₄H₈O₂ | 77 | −83.6 | 0.894 | 8.7 | 0.228 | 11 | −4 |
| Ethylene glycol | C₂H₆O₂ | 197 | −13 | 1.115 | M | 0.790 | 4.7 | 111 |
| Glycerin | C₃H₈O₃ | 290 | 17.8 | 1.261 | M | 0.812 | 13 | 160 |
| Methanol | CH₄O | 64.6 | −98 | 0.791 | M | 0.762 | 5.6 | 12 |
| Methyl t-butyl ether | C₅H₁₂O | 55.2 | −109 | 0.741 | 4.8 | 0.148 | 4 | −28 |
| (MTBE) | | | | | | | | |
| 1-Propanol | C₃H₈O | 97 | −126 | 0.803 | M | 0.617 | 1.9 | 15 |
| 2-Propanol | C₃H₈O | 82.4 | −88.5 | 0.785 | M | 0.546 | 5.0 | 12 |
| Water | H₂O | 100.00 | 0.00 | 0.998 | M | 1.000 | | |
| water, heavy (D₂O) | D₂O | 101.3 | 4 | 1.107 | M | 0.991 | | |

B. Detergents

Contemplated detergents include polyoxyalkylene derivatives, which includes partial esters of sorbitol anhydrides, such as Tween 80 and polysorbate 80, and non-ionic oil soluble water detergents such as Triton X 100 (oxyethylated alkylphenol). Also contemplated are anionic detergents such as bile salts, including sodium deoxycholate, and amphoteric detergents, such as Zwitergents.

Some typical nonionic detergents are alkyl aryl polyether sulfates, alcohol sulfonates, alkyl phenol polyglycol ethers, and polyethylene glycol alkyl aryl ethers.

Preferred detergents are non-ionic because they are less denaturing and are useful to solubilize membrane proteins and lipids while retaining protein-protein interactions. Contemplated non-ionic detergents in addition to the preferred Tween 80 and polysorbate 80, include Octylglucoside, Digitonin, C₁₂E₈, Lubrol, and Nonident P-40. A detergent concentration of 0.01 to 10.0% (v/v), in particular 0.1 to 1.0% (v/v) is preferably used.

Other exemplary nonionic detergents are listed in Table 2 below:

TABLE 2
Nonionic Detergents

| | | | CMC | M. W. of | |
|---|---|---|---|---|---|
| Detergent | Detergent Type | M. W. | (mM) | Micelle | Structure |
| Octylglucopyranoside | Non-ionicAlkyl glucoside | 292.4 | 20-25 | — | 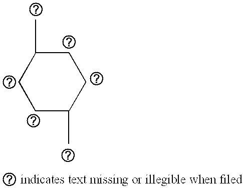 |
| Dodecylmaltopyranoside | Non-ionicAlkly maltoside | 510.6 | 0.1-0.6 | 50,039 | 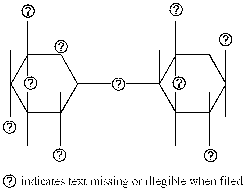 |
| Heptylthioglucopyranoside | Non-ionicAlkyl thioglucoside | 274.3 | CMC | — | 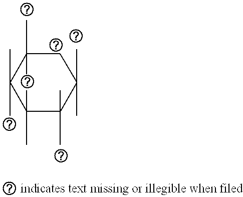 |
| Big CHAP | Non-ionicBig CHAP series | 878.1 | 3-4 | 8,871 | 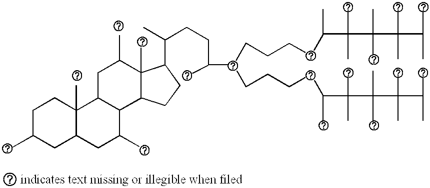 |
| Digitonin | Non-ionicDigitonin | 1229.3 | — | — | |
| MEGA 10 | Non-ionicGlucamide | 349.5 | 6-7 | — | 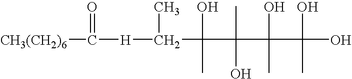 |
| Genapol X-080 | Non-ionicPolyoxyethylene | 553 (avg.) | 0.06-0.15 | — | 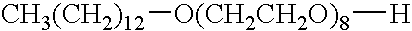 |
| NP-40 | Non-ionicPolyoxyethylene | 603.0 | 0.05-0.3 | — | 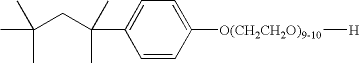 |
| Pluronic F-127 | Non-ionicPolyoxyethylene | 12600 (avg.) | — | — | 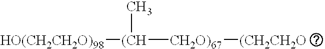 |
| Triton X-100 | Non-ionicPolyoxyethylene | 650.0 | 0.25 | — | 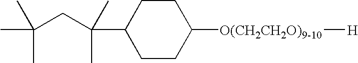 |
| Tween 20 | Non-ionicPolyoxyethylene | 1228 (avg.) | 0.059 | — | 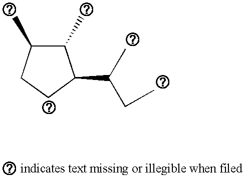 |
| CHAPS | ZwitterionicCHAPS series | 614.9 | 6-10 | 2,460-8,609 | 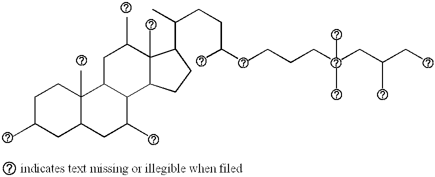 |

### Solvent/Detergent Removal

At the completion of treatment, the SD reagents must be removed. Ideally, the solvent and detergent are removed simultaneously with the isolation of the hemoglobin. However, in instances where it is desirable to remove the solvent and detergent separately, the World Health Organization provides the following guidelines: Solvent and detergent removal is typically accomplished by extraction with 5% vegetable oil, positive adsorption chromatography where the protein of interest binds to a chromatographic resin, or adsorption of the reagents on a C18 hydrophobic resin. Depending on the volume of product infused and the frequency of infuision ,permnitted residual levels of TNBP, Tween 80 and Triton X-100 typically are 3-25, 10-100, and 3-25 ppm, respectively.

### Viral Clearance Standards and Validation

Any degree of viral clearance using the present invention is desirable. However, it is desirable to achieve the degree of viral clearance necessary to meet strict safety guidelines for pharmactuticals. These guidelines are set forth by the World Health Organization and well known to those of skill in the art.

### Modifications of Hemoglobin

In one embodiment of the present invention, the hemoglobin is modified during or after isolation. A preferred modification to hemoglobin is “surface-modification,” i.e. covalent attachment of chemical groups to the exposed amino acid side chains on the hemoglobin molecule.

Modification is carried out principally to increase the molecular size of the hemoglobin, most often by covalent attachment of polymeric moieities such as synthetic polymers, carbohydrates, proteins and the like. Generally, synthetic polymers are preferred.

Suitable synthetic hydrophilic polymers include, inter alia, polyalkylene oxide, such as polyethylene oxide ((CH2CH2O)n), polypropylene oxide (CH(CH3)CH2O)n) or a polyethylene/polypropylene oxide copolymer ((CH2CH2O)ₙ-(CH(CH3)CH2O)n). Other straight, branched chain and optionally substituted synthetic polymers that would be suitable in the practice of the present invention are well known in the medical field.

Most commonly, the chemical group attached to the hemoglobin is polyethylene glycol (PEG), because of its pharmaceutical acceptability and commercial availability. PEGs are polymers of the general chemical formula H(OCH₂CH₂)ₙOH, where n is generally greater than or equal to 4. PEG formulations are usually followed by a number that corresponds to their average molecular weight. For example, PEG-200 has an average molecular weight of 200 and may have a molecular weight range of 190-210. PEGs are commercially available in a number of different forms, and in many instances come preactivated and ready to conjugate to proteins.

In a preferred embodiments of the present invention, surface modification takes place when the hemoglobin is in the oxygenated or “R” state. This is easily accomplished by allowing the hemoglobin to equilibrate with the atmosphere (or, alternatively, active oxygenation can be carried out) prior to conjugation. By performing the conjugation to oxygenated hemoglobin, the oxygen affinity of the resultant hemoglobin is enhanced. Such a step is generally regarded as being contraindicated, since many researchers describe deoxygenation prior to conjugation to diminish oxygen affinity. See, e.g., U.S. Pat. No. 5,234.903.

Although in many respects the performance of surface modified hemoglobins is independent of the linkage between the hemoglobin and the modifier (e.g. PEG), it is believed that more rigid linkers such as unsaturated aliphatic or aromatic C₁ to C₆ linker substituents may enhance the manufacturing and/or characteristics of the conjugates when compared to those that have more flexible and thus deformable modes of attachment.

The number of PEGs to be added to the hemoglobin molecule may vary, depending on the size of the PEG. However, the molecular size of the resultant modified hemoglobin should be sufficiently large to avoid being cleared by the kidneys to achieve the desired half-life. Blumenstein, et al., determined that this size is achieved above 84,000 molecular weight. (Blumenstein, et al., in “Blood Substitutes and Plasma Expanders,” Alan R. Liss, editors, New York, N.Y., pages 205-212 (1978)). Therein, the authors conjugated hemoglobin to dextran of varying molecular weight. They reported that a conjugate of hemoglobin (with a molecular weight of 64,000) and dextran (having a molecular weight of 20,000) “was cleared slowly from the circulation and negligibly through the kidneys,” but increasing the molecular weight above 84,000 did not alter the clearance curves. Accordingly, as determined by Blumenstein, et al., it is preferable that the HBOC have a molecular weight of at least 84,000.

In one embodiment of the present invention, the HBOC is a “MaIPEG,” which stands for hemoglobin to which malemidyl-activated PEG has been conjugated. Such MaIPEG may be further referred to by the following formula:

Hb-S-Y-R-CH₂-CH₂-[O—CH₂-CH₂]ₙ-O—CH₃)ₘ Formula I
where Hb refers to tetrameric hemoglobin, S is a surface thiol group, Y is the succinimido covalent link between Hb and Mal-PEG, R is an alkyl, amide, carbamate or phenyl group (depending on the source of raw material and the method of chemical synthesis), [O—CH₂-CH₂]ₙ are the oxyethylene units making up the backbone of the PEG polymer, where n defines the length of the polymer (e.g., MW=5000), and O—CH₃ is the terminal methoxy group.

Accordingly, in the practice of the present invention, an activated polyalkylene oxide can be added to modify the hemoglobin at different times during the procedure: 1) at the same time that solvent and detergent are added to the suspension of intact or lysed red blood cells, 2) after the solvent and detergent step but before the free hemoglobin has been isolated from the stroma, or 3) added to the free hemoglobin after it has been isolated from the stroma.

### EXAMPLES

The following experiments demonstrate that solvent-detergent virus removal does not substantially diminish hemoglobin activity as measured in terms of percent methemoglobin (metHb). In addition, Example 3 demonstrates that solvent-detergent treatment is efficient at lysing red blood cells. Taken together, these experiments demonstrate that, when combined with a method of purifying hemoglobin from red blood cells, solvent-detergent treatment serves the dual purpose of solubilizing red blood cell membranes and deactivating viruses.

### Example 1

Production of Stroma-Free

Outdated packed red blood cells are procured from a commercial source. Preferably, outdated material is received not more than 45 days from the time of collection. Packed RBCs (pRBCs) are stored at 4±2° C. until used.

Packed red blood cells are pooled into a sterile vessel in a clean facility. Hemoglobin concentration is determined using a commercially available co-oximeter or other art-recognized method.

Leukodepletion (i.e. removal of white blood cells) is carried out using membrane filtration. Initial and final leukocyte counts are made to monitor the efficiency of this process.

Red blood cells are washed with six volumes of 0.9% sodium chloride. The process is carried out at 4±2° C. The cell wash is analyzed to verify removal of plasma components by a spectrophotometric assay for albumin.

Washed red blood cells are lysed at 4±2° C. with stirring using 6 volumes of water. Lysate is processed in the cold to purify hemoglobin. This is achieved by processing the lysate through a 0.16-μm membrane. Purified hemoglobin is collected into a sterile depyrogenated vessel. All steps in this process are carried out at 4±2° C.

Hemoglobin is exchanged into Ringer's lactate (RL) or phosphate-buffered saline (PBS, pH 7.4) using a 10-kD membrane. The hemoglobin is then concentrated using the same membrane to a final concentration of 1.1-1.5 mM (in tetramer). Ten to 12 volumes of RL or PBS are used for solvent exchange. This process is carried out at 4±2° C. The pH of the solution prepared in RL is adjusted to 7.0-7.6.

The hemoglobin solution is then sterile-filtered through a 0.45- or 0.2-μm disposable filter capsule and stored at 4±2°.

### Example 2

Effects of Solvent-Detergent on Stroma Free Hemoglobin

In order to study the effects of solvent-detergent viral inactivation on stroma free hemoglobin, three different parameters were measured:
a) Total hemoglobin
b) Percentage met-hemoglobin and
c) Spectral properties of hemoglobin.

Testing was performed using stroma free hemoglobin (SFH) prepared as described above, with a hemoglobin concentration of 8.6-9.0 g % in PBS.

The solvent-detergent treatment was performed at a concentration of 1% Tween 80 (solvent) and 0.3% Tri-N-Butyl Phosphate (detergent). (This combination is known to be efficient at inactivating viruses.) Testing was performed at 21-23° C. with continuous mixing for 5 hours. All testing was performed at neutral pH in phosphate buffered saline.

After treatment, the mixture was centrifuged at 8,000 rpm (4,600 g) for 6 minutes at room temperature.

The results are summarized in the following three tables. As shown, solvent-detergent does not significantly change the met-Hb percentage (<20% change) or total hemoglobin concentration (<5% change) over 5 hours at 21-23° C.

TABLE 1
Percentage Met-Hb over time

| | | | SFH + TNBP + |
|---|---|---|---|
| Time | SFH | SFH | Tween 80 |
| (hrs) | (2-6° C.) | (21-23° C.) | (21-23° C.) |
| 0 | 2.15 | 2.2 | 2.55 |
| 1 | 2.2 | 2.4 | 2.5 |
| 2 | 2.25 | 2.45 | 2.75 |
| 3 | 2.15 | 2.45 | 2.85 |
| 4 | 2.1 | 2.6 | 3 |
| 5 | 2.25 | 2.8 | 3.1 |

TABLE 2
Total Hb (g %) over time

| | | | SFH + TNBP + |
|---|---|---|---|
| Time | SFH | SFH | Tween 80 |
| (hrs) | (2-6° C.) | (21-23° C.) | (21-23° C.) |
| 0 | 8.6 | 8.5 | 8.15* |
| 1 | 8.5 | 8.55 | 8.15* |
| 2 | 8.55 | 8.55 | 8.2* |
| 3 | 8.65 | 8.65 | 8.2* |
| 4 | 8.65 | 8.6 | 8.1* |
| 5 | 8.55 | 8.55 | 8.15* |

*Reduced hemoglobin concentration was due to addition of S/D

### Example 3

### Effects of Solvent-Deterzent on Red Blood Cells

pRBC's were exposed to 1% Tween-80 (solvent) and 0.3% Tri N-Butyl Phosphate (detergent) for 15 minutes at room temperature. Based on centrifugation studies, the cells were efficiently (>95%) lysed under these conditions, while control pRBC's not exposed to solvent-detergent remained unchanged.

The examples set forth above are provided to give those of ordinary skill in the art with a complete disclosure and description of how to make and use the preferred embodiments of the compositions, and are not intended to limit the scope of what the inventors regard as their invention. Modifications of the above-described modes for carrying out the invention that are obvious to persons of skill in the art are intended to be within the scope of the following claims. All publications, patents, and patent applications cited in this specification are incorporated herein by reference as if each such publication, patent or patent application were specifically and individually indicated to be incorporated herein by reference.

We claim:

1. A method for isolating virus free hemoglobin from red blood cells comprising the steps of:
a) contacting a suspension of intact or lysed red blood cells with a detergent and an organic solvent to produce free hemoglobin and strom a; and
b) isolating the free hemoglobin from the stroma and the detergent and the organic solvent.

2. The method of claim 1, wherein step a) further comprises contacting a suspension of intact red blood cells with a detergent and an organic solvent to produce free hemoglobin and stroma.

3. The method of claim 1, wherein step a) further comprises contacting a suspension of lysed red blood cells with a detergent and an organic solvent to produce free hemoglobin and stroma.

4. The method of claim 3, further comprising the step of lysing the red blood cells prior to step a).

5. The method of claim 4, wherein the step of lysing the red-blood cells further comprises exposing the red blood cells to a hypotonic solution.

6. The method of claim 5, wherein the hypotonic solution is water, buffer, or salt solution.

7. The method of claim 4, wherein the step of lysing the red blood cells further comprises exposing the red blood cells to physical conditions that disrupt the cell membranes.

8. The method of claim 7, wherein the physical conditions are performed by sonication, agitation, or shear forces.

9. The method of claim 1, wherein the free hemoglobin is isolated from the stroma by centrifugation, filtration, dialysis, or chromatography.

10. The method of claim 1, wherein the free hemoglobin is isolated from the stroma by ion exchange chromatography.

11. The method of claim 1, wherein the detergent is anionic, cationic, amphoteric, or nonionic.

12. The method of claim 11, wherein the nonionic detergent is a polyoxyethylene derivative of a fatty acid.

13. The method of claim 12, wherein the polyoxyethylene derivative of a fatty acid is polyoxyethylenesorbitan monooleate (Tween 80) or polyoxyethylated alkylphenol (Triton X-100).

14. The method of claim 1, wherein the organic solvent is an ether, an alcohol, or a trialkyl phosphate.

15. The method of claim 14, wherein the organic solvent is ether.

16. The method of claim 15, wherein the ether has the formula
R¹-O-R²
wherein, R¹ and R² are independently C₁ to C₁₈ substituted or unsubstituted alkyl or alkenyl groups.

17. The method of claim 14, wherein the organic solvent is alcohol.

18. The method of claim 17, wherein the alcohol has 1-8 carbon atoms.

19. The method of claim 17, wherein the alcohol is methanol, ethanol, propanol, isopropanol, n-butanol, isobutanol, n-pentanol or isopentanol.

20. The method of claim 14, wherein the organic solvent is a trialkyl phosphate.

21. The method of claim 20, wherein the trialkyl phosphate is tri (n-butyl) phosphate (TNBP).

22. The method of claim 1, wherein the organic solvent is present at a concentration of about 0.01% to about 1.0% (v/v).

23. The method of claim 22, wherein the organic solvent is present at about 0. 1% to about 0.5% (v/v).

24. The method of claim 1, wherein the organic solvent is present at a concentration of 0.01 to 1%(v/v).

25. The method of claim 1, wherein step a) is performed at 4° C. to 24° C. for a minimum of 4 hours, and wherein the detergent is polyoxyethylated alkylphenol (Triton X-100).

26. The method of claim 1, wherein step a) is performed at 4° C. to 24° C. for a minimum of 6 hours, and wherein the detergent is polyoxyethylenesobitan monooleate (Tween 80).

27. A method for isolating virus free hemoglobin from red blood cells comprising the steps of:
a) contacting a suspension of intact red blood cells with polyoxyethylenesorbitan monooleate (Tween 80) or poly oxyethylated alkylphenol (Triton X-100), and tri (n-butyl) phosphate (TNBP), to produce free hemoglobin and stroma; and
b) isolating the free hemoglobin from the stroma and the detergent and the organic solvent;

28. A method for producing polyalkylene oxide modified hemoglobin from virus free hemoglobin derived from red blood cells comprising the steps of:
a) contacting a suspension of intact or lysed red blood cells with a detergent and an organic solvent to produce free hemoglobin and stroma; and
b) isolating the free hemoglobin from the stroma and the detergent and the organic solvent;
wherein the method farther comprises the step of exposing the free hemoglobin to an activated polyalkylene oxide to produce polyalkylene oxide modified hemoglobin during step a), in-between step a) and b), during step b), or after step b).
